(19) United States
(12) Patent Application Publication
(10) Pub. No.: US 2010/0228399 A1
(43) Pub. Date: Sep. 9, 2010

(54) PRESSURE REGULATOR ASSEMBLY AND SYSTEM FOR THE CONTROLLED STORAGE AND DISPENSING OF A FLUID

(76) Inventors: Richard J. UDISCHAS, Newark, DE (US); Denis Müller, Rueil Malmaison (FR); Werner SCHLESER, Marcel (FR)

Correspondence Address: AIR LIQUIDE USA LLC;Intellectual Property, 2700 POST OAK BOULEVARD, SUITE 1800, HOUSTON, TX, 77056, US

(21) Appl. No.: 12/762,776

(22) Filed: Apr. 19, 2010

Related U.S. Application Data
(63) Continuation-in-part of application No. 12/328,377, filed on Dec. 4, 2008.
(60) Provisional application No. 61/170,461, filed on Apr. 17, 2009.
(60) Provisional application No. 60/992,967, filed on Dec. 6, 2007.

(51) Int. Cl. G05D 16/02; G05D 7/06; G05D 16/00

(52) U.S. Cl. 700/282; 137/613

(57) ABSTRACT

A pressure regulator assembly includes an integrated body. The integrated body has an inlet for connecting to a gas cylinder, a bore extending from the inlet to a pressure regulator, a passage extending from the pressure regulator to an outlet, and a fill port in communication with the bore. The pressure regulator assembly includes the pressure regulator operable to reduce pressure of a fluid flowing therethrough between the bore and the passage to a sub-atmospheric pressure; and an isolation valve operable between an open position and a closed position. The isolation valve is operable to seal the passage from the outlet in the closed position and to provide fluid communication between the outlet and the passage in the open position.

### CROSS-REFERENCE TO RELATED APPLICATIONS

This application claims the benefit under 35 U.S.C. §119(e) to provisional application No. 61/170,461, filed Apr. 17, 2009, the entire contents of which are incorporated herein by reference.

This application is a continuation-in-part of U.S. patent application Ser. No. 12/328,377, filed Dec. 4, 2008, which claims priority to provisional application No. 60/992,967, filed Dec. 6, 2007, the entire contents of which are incorporated herein by reference.

### BACKGROUND

Pressure regulators are typically used for bringing a gas from its transport or storage pressure to its service pressure and then dispensing the gas at this service pressure. Not only is it important that such gases be dispensed precisely or that the purity of such gases be accurately preserved, in the case where such gases are considered to be hazardous or toxic to the operator of the system, it is also important that the operator be protected from exposure to such gases. More specifically, in areas such as the manufacture of electronics, photovoltaic solar cells, flat panel display manufacture, LED manufacture, laboratory analysis and the like, materials that are utilized often qualify as hazardous materials since contact with these materials would be considered to be harmful and/or dangerous to the operator of such a system. It is therefore important to be able to provide a safe and effective manner for operators to handle such hazardous materials at either super-atmospheric pressures or sub-atmospheric pressures to minimize the possible dangers to operators.

A number of systems are currently available for the storage and dispensing of hazardous gases at sub-atmospheric pressures but each of these has their own drawbacks. More specifically, there are systems which seek to minimize the hazards by placing the dispenser inside the gas cylinder. Such systems reduce the capacity of the gas cylinder and are incompatible with liquefied gas. In addition, such systems present problems when the cylinders are placed on their side. Other systems exist which utilize adsorbents for the storage of the hazardous gases. However, these systems are also limited in their capacity due to the inclusion of adsorbents, the capacity limitation of the adsorbent for the molecule to be adsorbed, desorption due to exposure to temperatures higher than indoor temperatures and issues with purity.

Typically customers operate the gas cylinders until they are virtually empty. This gives no advance warning of when to prepare a cylinder for replacement and causes production disruption and inconvenient shutdown times.

Accordingly, there exists a need for a regulator assembly which minimizes dangerous risks often associated with the storage and dispensing of hazardous materials while at the same time not foregoing storage capacity and ease of dispensing.

### SUMMARY

In one embodiment, a pressure regulator assembly includes an integrated body. The integrated body has an inlet for connecting to a gas cylinder, a bore extending from the inlet to a pressure regulator, a passage extending from the pressure regulator to an outlet, and a fill port in communication with the bore. The pressure regulator assembly includes the pressure regulator operable to reduce pressure of a fluid flowing therethrough between the bore and the passage to a sub-atmospheric pressure; and an isolation valve operable between an open position and a closed position. The isolation valve is operable to seal the passage from the outlet in the closed position and to provide fluid communication between the outlet and the passage in the open position.

In another embodiment, a fluid delivery system includes a gas cylinder and a pressure regulator assembly. The pressure regulator assembly includes an integrated body. The integrated body has an inlet connected to the gas cylinder, a bore extending from the inlet to a pressure regulator, a passage extending from the pressure regulator to an outlet, a fill port in communication with the bore, and a longitudinal axis coaxial with a longitudinal axis of the gas cylinder. The pressure regulator assembly includes the pressure regulator operable to reduce pressure of a fluid flowing therethrough between the bore and the passage; and an isolation valve operable between an open position and a closed position. The isolation valve is operable to seal the passage from the outlet in the closed position. The isolation valve is operable to provide fluid communication between the outlet and the passage in the open position.

In another embodiment, a failsafe pressure regulator assembly includes an integrated body. The integrated body has an inlet for connecting to a gas cylinder, a bore extending from the inlet to a pressure regulator, a passage extending from the pressure regulator to an outlet, and a fill port in communication with the bore. The pressure regulator assembly includes the pressure regulator operable to reduce pressure of a fluid flowing therethrough between the bore and the passage to a sub-atmospheric pressure. The pressure regulator includes a gland connected to the body, a diaphragm, an actuator operable to adjust the sub-atmospheric pressure, a governor operable to limit the adjustability to a sub-atmospheric pressure, and one or more seals operable to contain the fluid in the gland and the actuator in response to failure of the diaphragm. The pressure regulator assembly further includes an isolation valve operable between an open position and a closed position. The isolation valve is operable to seal the passage from the outlet in the closed position and to provide fluid communication between the outlet and the passage in the open position.

In another embodiment, a method of dispensing hazardous fluid from a gas cylinder includes connecting a system to a process line. The system includes a pressure regulator assembly and the gas cylinder. The method further includes setting the pressure regulator assembly to feed the hazardous fluid to a process via the process line; dispensing the hazardous fluid from the cylinder to the process line using the pressure regulator assembly; and monitoring operation of the regulator using a programmable logic controller (PLC) and a pressure sensor in communication with an outlet of the pressure regulator assembly.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a cross-section of a pressurized source vessel, such as a gas cylinder.

FIG. 2 is a front view of the exterior of the pressure regulator assembly, according to one embodiment of the present invention.

FIG. 3 is a side view of the exterior of the pressure regulator assembly.

FIG. 4a is a top view of the pressure regulator assembly.

FIG. 4b is a front cross-section of the pressure regulator assembly taken along cut line 4b-4b of FIG. 4a.

FIG. 4c is a side cross-section of the pressure regulator assembly taken along cut line 4c-4c of FIG. 4a.

FIG. 5 is a front view of a pressure regulator assembly, according to another embodiment of the present invention.

FIG. 6 is a perspective view of the pressure regulator assembly fastened to the gas cylinder.

FIG. 7 is a cross-section of the pressure regulator.

FIG. 8 illustrates the pressure regulator assembly connected to a process line, according to another embodiment of the present invention.

FIG. 9 illustrates functionality of a programmable logic controller (PLC), according to another embodiment of the present invention.

### DESCRIPTION OF PREFERRED EMBODIMENTS

Disclosed is a pressure regulator assembly for use in a system for the controlled storage and dispensing of a hazardous material at either super-atmospheric pressure or sub-atmospheric pressure. The system comprises at least a pressurized source vessel and the disclosed pressure regulator assembly. These systems are often used in industrial processes and applications, including areas such as semiconductors manufacturing, to supply hazardous materials to downstream systems. The present system is contemplated to supply a hazardous material directly to a downstream system (including having the system directly in the room where the downstream system is being utilized) or to supply a hazardous material to a manifold which will then supply the hazardous material to one or more downstream systems.

As used herein, the phrase “hazardous material(s)” refers to any material which because of its corrosive or toxic nature may cause temporary or permanent damage or harm to a person who comes in contact with the hazardous material. One of the objectives of the disclosed pressure regulator assembly is to minimize the dangerous risks associated with the storage and dispensing of hazardous materials for the operators that are working either directly or indirectly with such systems as those described herein. Examples of materials which are considered to be hazardous materials within the scope of the present invention include, but are not limited to, PH₃, BF₃, AsH₃, GeH₄, H₂Se, COS, TMB (trimethyl boron), GeF₄, AsF₅, SiH₄, NF₃ and PF₃. From within this group of noted hazardous materials, in general, when the system utilized includes a sub-atmospheric pressure regulator assembly, non-limiting examples of the hazardous material(s) contemplated to be stored and dispensed will typically be PH₃, BF₃, AsH₃. In general, when the system utilized includes a super-atmospheric pressure regulator assembly, non-limiting examples of the hazardous material(s) contemplated to be stored and dispensed will typically be GeH₄, H₂Se, COS, TMB (trimethyl boron), GeF₄, AsF₅, SiH₄, NF₃ and PF₃. Those of ordinary skill in the art will recognize that these groupings (for sub-atmospheric pressure regulators and super-atmospheric regulators) are not meant to be limited and are instead illustrative of the types of hazardous materials typically utilized under such pressure conditions. In addition, the hazardous materials are not meant to be a limiting factor with regard to the present invention and accordingly may comprise any hazardous material which meets the above noted definition.

The disclosed system comprises a pressurized source vessel having mounted thereon an pressure regulator assembly that is a pressure regulator/valve assembly. The pressurized source vessel can be any cylinder or other appropriate container that is typically utilized for storing and supplying the hazardous materials as described herein, provided that the vessel has a neck portion and an interior space for holding a hazardous material in either a liquefied gas form or a compressed gas form and further that the neck portion has a vessel outlet that traverses the neck portion and is in communication with the interior space through which the hazardous material can flow. The vessel outlet serves as an outlet for the flow of the hazardous material. The pressurized source vessel can be made of any material that is not susceptible to the effects of coming in contact with the hazardous material stored therein and must have the ability to withstand high degrees of pressure. Typically such vessels will be made of carbon steel, aluminum or stainless steel although those of ordinary skill in the art will recognize that other types of materials may be used to make these vessels.

As noted, the disclosed pressure regulator assembly is for use with a pressurized source vessel. The pressure regulator assembly includes an integral body, an assembly outlet, a defined internal passage, a pressure regulator, an isolation valve and a filling port. The internal body of the pressure regulator assembly is basically the housing for the system. The integral body has a base portion that includes an axis for mounting on and coaxially with the neck portion of the pressurized source vessel. The mounting is made in such a way that when the conditions are such as to allow the flow of hazardous material from the pressurized source vessel, the hazardous material flows through the vessel outlet of the neck portion of the pressurized source vessel and into the pressure regulator assembly where it is further distributed. The base portion may be mounted to the pressurized source vessel in any number of manners including but not limited to being threadably mounted at a specific torque setting as those of ordinary skill in the art will recognize in order to provide a leakproof seal or by any other method known to those of ordinary skill in the art. Regardless of the means utilized to mount the base portion of the integral body to the neck portion of the pressurized source vessel, it is important to make certain that the mounting is secure and thoroughly sealed in order to prevent leakage of the hazardous material when the hazardous material flows from the pressurized source vessel and into the integrated valve regulator assembly. While the integral body may be any type of material which is not susceptible to the effects of coming in contact with the hazardous materials, the preferred material for making the integral body is stainless steel, nickel or nickel based alloy.

The pressure regulator assembly also includes an assembly outlet which serves as the point where the hazardous material will exit the pressure regulator assembly under specific conditions as further defined herein. This assembly outlet also serves as the point of connection to and between a specific system or a manifold that is capable of sending hazardous material further downstream to one or more downstream systems. The assembly outlet may include a locking mechanism which prevents the inadvertent opening of the assembly outlet and serves as a safety measure when the system is not connected to a downstream system. The locking mechanism may comprise any mechanism which “locks” the outlet until it is connected to a downstream system. Typically this locking mechanism will comprise a plug which is placed in the opening of the outlet and a cap that is locked into place and requires the use of a cap key to remove the cap.

The integral body of the gas delivery system further includes a defined internal passage in the integral body. This defined internal passage is a single path or passageway that extends through the integral body between the base portion of the integral body and the assembly outlet. The upstream portion of the defined internal passage is in communication with the vessel outlet of the pressurized source vessel and therefore also serves as the assembly inlet for receiving the hazardous material from the pressurized source vessel. In other words, hazardous material will flow through the vessel outlet of the pressurized source vessel into the upstream portion of the defined internal passage where it will then continue to flow through the defined passageway of the defined internal passage.

In one embodiment, the pressure regulator assembly also includes a sub-atmospheric pressure regulator within the integral body of the pressure regulator assembly. The sub-atmospheric pressure regulator lies along the passageway of the defined internal passage with the integral body forming the actual housing of the sub-atmospheric pressure regulator which contains the means for providing sub-atmospheric pressure. As used herein, the phrase “sub-atmospheric” refers to a pressure that is less than one atmosphere. Furthermore, with regard to this particular embodiment, the means for providing sub-atmospheric pressure comprises a poppet and diaphragm which respond by remaining closed unless downstream is at less than one atmosphere in which case the means opens and allows hazardous material to flow therethrough. The means for providing sub-atmospheric pressure may further comprise an additional safety in the form of two sets of seal rings to allow for double leak tightness in the event that one or more of the other components of the means for providing sub-atmospheric pressure fail. The sub-atmospheric pressure regulator does not contain one set point but instead responds to pressure over a range with this response depending upon the pressure in the source vessel and the pressure applied to the system via the assembly outlet. Accordingly, with regard to when a sub-atmospheric pressure regulator is utilized, the hazardous material will flow through the sub-atmospheric pressure regulator at a pressure that typically ranges from about 50 Torr to about 600 Torr, depending upon the pressure in the pressurized source vessel and the pressure to be applied to the assembly outlet. As noted, the corresponding means for responding to pressure is disposed within the defined internal passage and allows for the passage of hazardous material in gas form when the means for providing sub-atmospheric pressure senses a sub-atmospheric pressure downstream of the sub-atmospheric pressure regulator.

In a still further embodiment, the pressure regulator assembly will alternatively include a super-atmospheric pressure regulator within the integral body of the pressure regulator assembly. Accordingly, the pressure regulator will be a super-atmospheric pressure regulator. As used herein, the phrase “super-atmospheric”refers to a pressure that is greater than one atmosphere. Furthermore, with regard to this particular embodiment, the means for providing super-atmospheric pressure comprises a poppet and diaphragm which respond to pressure by opening and allowing hazardous material to flow therethrough but remain closed when the pressure is not greater than one atmosphere. The means for responding to super-atmospheric pressure may further comprise an additional safety in the form of two sets of seal rings to allow for double leak tightness in the event that one or more of the other components of the means for responding to sub-atmospheric pressure fail. The super-atmospheric pressure regulator does not contain one set point but instead responds to pressure over a range with this response depending upon the pressure in the source vessel and the pressure applied to the system via the assembly outlet.

The pressure regulator assembly further includes an isolation valve positioned within the defined internal passage of the integral body of the pressure regulator assembly and located downstream from and in communication with the sub-atmospheric pressure regulator (or in the alternative embodiment, the super-atmospheric pressure regulator). The function of the isolation valve is to allow for the flow of hazardous material in gas form from the sub-atmospheric pressure regulator (or super-atmospheric pressure regulator) and through the isolation valve when the isolation valve is in an opened position. Alternatively, the isolation valves serves to block the flow of hazardous material in the gas form when the isolation valve is in a closed position. The isolation valve is connected downstream to the assembly outlet and therefore once the hazardous material flows through the isolation valve, it will exit the integrated valve regulator assembly and flow further downstream to its point of use. The isolation valve can be operated manually utilizing a handwheel or may be operated utilizing an automatic actuator such as those readily known in the art.

The pressure regulator assembly still further comprises a filling port that is disposed between the axis for mounting on and coaxially with the neck portion of the pressurized source vessel and the sub-atmospheric pressure regulator (or in the alternative embodiment, the super-atmospheric pressure regulator). The filling port includes a site of injection. This site of injection serves to allow for the direct injection of hazardous material into the defined internal passage of the integral body. The site of injection has an associated filling valve which has an open position and a closed position and allows for the injection of hazardous material into the pressurized source vessel when the filling valve is in the opened position. As noted, the filling port will serve as the site for injecting the hazardous material. Note that hazardous material will be injected prior to the withdrawal of the hazardous material for use downstream. When the gas delivery system is in use for dispensing hazardous material to a downstream system, the filling port will not be in use. This is further ensured through the use of a variety of plugs and caps to secure the site of injection of the filling port and the associated filling valve. More specifically, the filling port may further comprise a safety plug that is positioned within the site of injection of the filling port and a safety cap that is positioned on the exterior of the filling port with each requiring removal prior to the filling valve being opened to allow for the injection of hazardous material into the pressurized source vessel. Once the hazardous material has been injected into the pressurized source vessel, the safety plug and safety cap is replaced and the filling valve is closed in order to secure the filling port. Optionally, as a further safety precaution, the safety plug and safety cap may each require a separate key to remove the safety plug and safety cap. Furthermore, the filling valve may include a locking mechanism for when the filling valve is not in use. The filling valve may be operated (opened or closed) utilizing either a handwheel or an automatic actuator of the type known in the art. The handwheel is removed and a cap is placed over the position of the handwheel. The cap requires a special key to remove it in order to put the handwheel in position to open the filling valve.

With regard to the system for the controlled storage and dispensing of a hazardous material, in the embodiment where a sub-atmospheric pressure regulator is used, when a downstream system under vacuum is connected to the pressure regulator assembly of the system via the assembly outlet and the isolation valve is placed in the opened position, hazardous material in gas form flows from the interior space of the pressurized source vessel through the vessel outlet, into the upstream portion of the defined internal passage, along the defined internal passage through the sub-atmospheric pressure regulator and isolation valve and out the assembly outlet where the hazardous material in gas form is delivered to the point of use at sub-atmospheric pressure either directly or though a manifold.

With regard to the system for the controlled storage and dispensing of a hazardous material, in the embodiment where a super-atmospheric pressure regulator is used, when a downstream system having a pressure greater than one atmosphere is connected to the pressure regulator assembly of the system via the assembly outlet and the isolation valve is placed in the opened position, hazardous material in gas form flows from the interior space of the pressurized source vessel through the vessel outlet, into the upstream portion of the defined internal passage, along the defined internal passage through the super-atmospheric pressure regulator and isolation valve and out the assembly outlet where the hazardous material in gas form is delivered to the point of use at super-atmospheric pressure either directly or though a manifold.

A still further embodiment involves the use of a vapor dip tube (also commonly referred to as a eductor) in order to provide an added safety measure for those instances where the hazardous materials being stored are present in both the liquefied gas form and the compressed gas or vapor form. The vapor dip tube prevents the flow of hazardous material in the liquefied gas form into the pressure regulator assembly in instances where the pressurized source vessel falls over, gets knocked over, or is positioned on its side. As used herein, the phrase “liquefied gas form” used in reference to hazardous materials refers to a hazardous material which under pressure is typically in a liquefied form but may also include gas/vapor form of the hazardous material. Non-limiting examples of such hazardous materials which are present in liquefied gas form under pressure include PH₃, AsH₃, GeH₄, H₂Se, COS, TMB, GeF₄, and AsF₅. The vapor dip tube includes a fritted end. Preferably, the fritted end of the vapor dip tube has a sintered metal element. The sintered metal element can be stainless steel, nickel, or nickel based alloy. Typically, the sintered metal element has a pore size equivalent from about 10 to about 200 μm, preferably from about 10 μm to about 50 μm.

When the vapor dip tube is present, it is connected to the upstream portion of the defined internal passage. The vapor dip tube is configured to extend from the upstream portion of the defined internal passage into the interior space of the pressurized source vessel when the base portion of the integral body is mounted on and coaxially with the neck portion of the pressurized source vessel, thereby providing communication between the defined internal passage and the interior space of the pressurized source vessel while at the same time preventing hazardous material in liquefied gas form from exiting the pressurized source vessel.

The vapor dip tube extends down into the pressurized source vessel and has a curvature that is considered to be outward and in the same direction of the location of the assembly outlet. This curve is therefore considered to be an outward bend pointing in the same direction as the assembly outlet. When the pressurized source vessel is in a horizontal position, the vapor dip tube is pointed up thereby preventing hazardous material in the liquefied gas form from flowing to the assembly outlet of the pressure regulator assembly.

While the degree of curvature may vary somewhat, the degree will typically range from about 30 to about 60° as measured from the axis that extends from that portion of the vapor dip tube that does not curve to the curve. The dimensions of the vapor dip tube may be any dimension for the disclosed purpose. Typically, the dimensions will vary depending upon the size of the pressurized source vessel. By way of example, typically, based on standard sized pressurized vessels (2.5 liters volume), the entire length of the vapor dip tube will range from about one inch to about five inches with the curved portion accounting for approximately 20 to 50% of this length. The width of the tube may also vary but will typically range from about 0.25 inches to about 0.75 inches.

Those of ordinary skill in the art will recognize that while the vapor dip tube is present in order to serve as a safety measure to prevent the leakage of fluid into the pressure regulator assembly and therefore the possible leakage of fluid from the system, the vapor dip tube may also be used in embodiments where the hazardous material is in gas form alone.

The disclosed pressure regulator assembly, regardless of embodiment, may further comprise any number of additional components such as a cap to further secure the pressure regulator assembly by completely covering during transport, or a filter just upstream of the pressure regulator to aid in removing any debris that may be present before the gas is passed through the pressure regulator (sub-atmospheric or super-atmospheric). The filter will typically be a sintered metal element that is stainless steel, nickel, or nickel based alloy with a pore size equivalent from about 10 to about 200 μm, preferably from about 10 μm to about 50 μm.

For a further understanding of the nature and objects of the present invention, reference is made to the detailed description, taken in conjunction with the accompanying figures, in which like elements are given the same or analogous reference numbers.

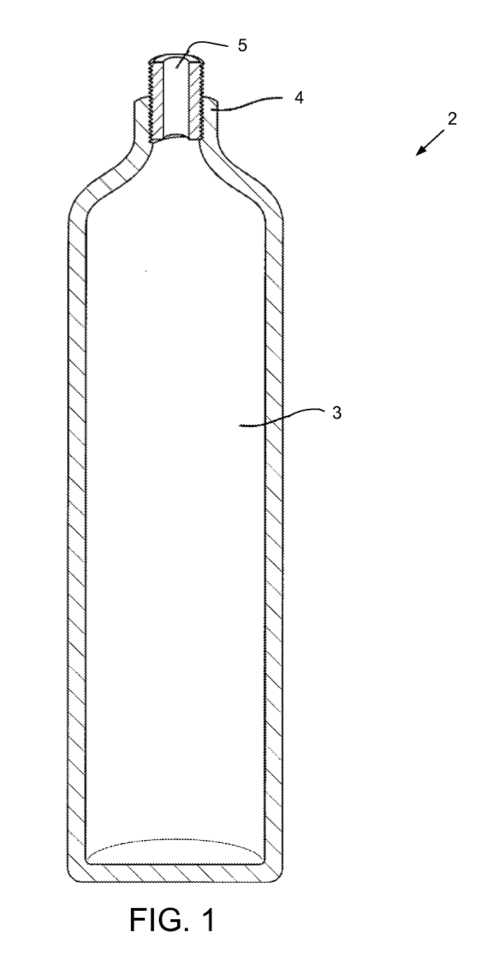

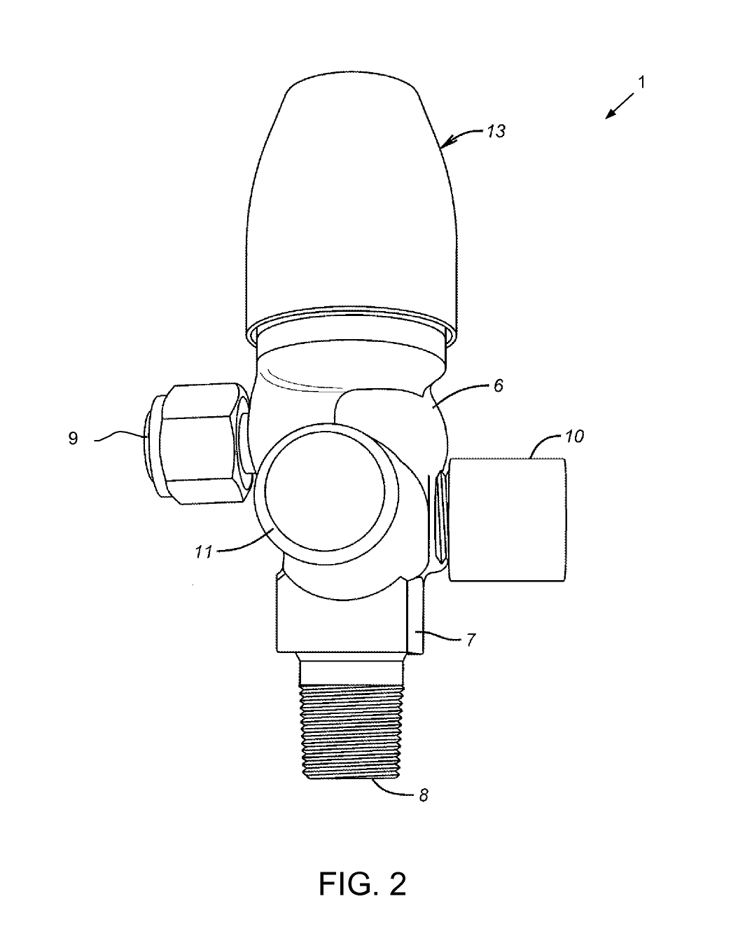

The disclosed pressure regulator assembly 1 is used with a pressurized source vessel 2 in order to supply hazardous materials to one or more downstream systems. FIG. 1 is a cross-section of a pressurized source vessel 2, such as a gas cylinder (sometimes also referred to as a gas bottle). The gas cylinder 2 may have an interior chamber 3 for holding hazardous fluid in a compressed gas phase or a liquefied gas (plus vapor) phase. The gas cylinder 2 may have a neck 4 which allows for the attachment of an integrated pressure regulator assembly 1 (shown in FIG. 2) to the gas cylinder 2. A vessel outlet 5 may be connected to the neck 4, such as by a threaded connection. The outlet 5 may traverse the neck 4 and serve as a path for the exit of the hazardous fluid from the gas cylinder 2 when the system is in use.

The gas cylinder 2 may be made of any material compatible with the hazardous fluid, such as a metal or alloy, such as plain carbon steel, low alloy steel, stainless steel, aluminum, nickel, or nickel based alloy. In a particular application, the hazardous fluid may be used in a semiconductor manufacturing process. Examples of the hazardous fluid include, but are not limited to, PH₃, BF₃, AsH₃, GeH₄, H₂Se, COS, TMB (trimethyl boron), GeF₄, AsF₅, SiH₄, NF₃ and PF₃.

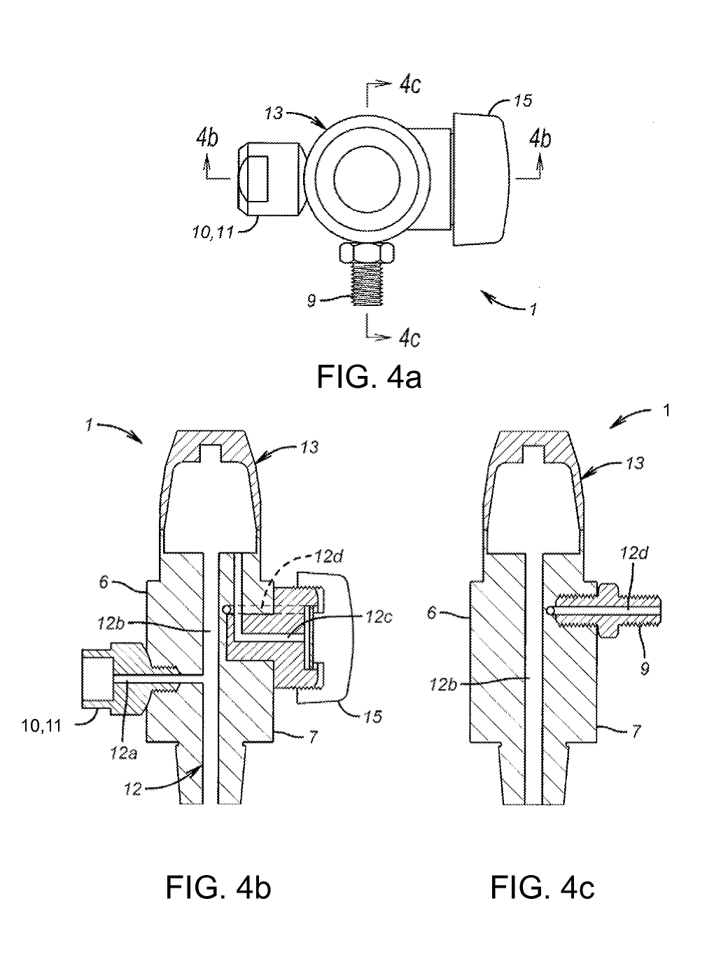

FIG. 2 is a front view of the exterior of the pressure regulator assembly 1, according to one embodiment of the present invention. The pressure regulator assembly 1 may include an integral body 6. The integral body 6 may be formed as a unitary piece of metal or alloy, such as by casting. The body 6 may have a base 7 and an inlet 8 for connection with the neck 4 of the gas cylinder 2, such as by a threaded connection 5. The base 7 may have a rectangular outer surface for receiving a wrench (not shown) to facilitate connection to the neck 4. The body 6 may have a bore 12b (see FIG. 4b) for receiving the hazardous fluid from the gas cylinder 2 and delivering the hazardous fluid to a pressure regulator 13. The regulator 1 may further include a fill coupling 10 connected to the body 6, such as by a threaded connection. The fill coupling 10 may include a port 12a (see FIG. 4b) for the direct injection of hazardous fluid into the gas cylinder 2 by way of the pressure regulator assembly 1. The regulator 1 may further include a fill valve 11 operable between an open position and a closed position. The valve 11 may provide fluid communication between the fill port 12a and regulator bore 12b in the open position. When the fill port 12a is not in use, the fill valve 11 may be in the closed position (not shown). The fill valve 11 may have a manual or automatic actuator (not shown). If automatic, the actuator may be electrically, hydraulically, or pneumatically operated. The regulator 1 may further include an outlet coupling 9 connected to the body 6, such as by a threaded connection, and having a port 12d (see FIG. 4c).

The body 6 may be made of a metal or alloy compatible with the hazardous fluid, such as stainless steel, nickel, or nickel based alloy. To facilitate safe transportation and storage, the outlet coupling 9 may be removed and a plug (not shown) may be connected to the body 6, such as by a threaded connection. The plug may have a cap requiring a cap key to remove the plug. Similarly, the fill coupling 10 may be replaced by plug (not shown) and cap when not in use. Similarly, if the fill valve 11 has a manual actuator (not shown), the actuator handle may be removed when not in use and replaced by a cap requiring a key to remove.

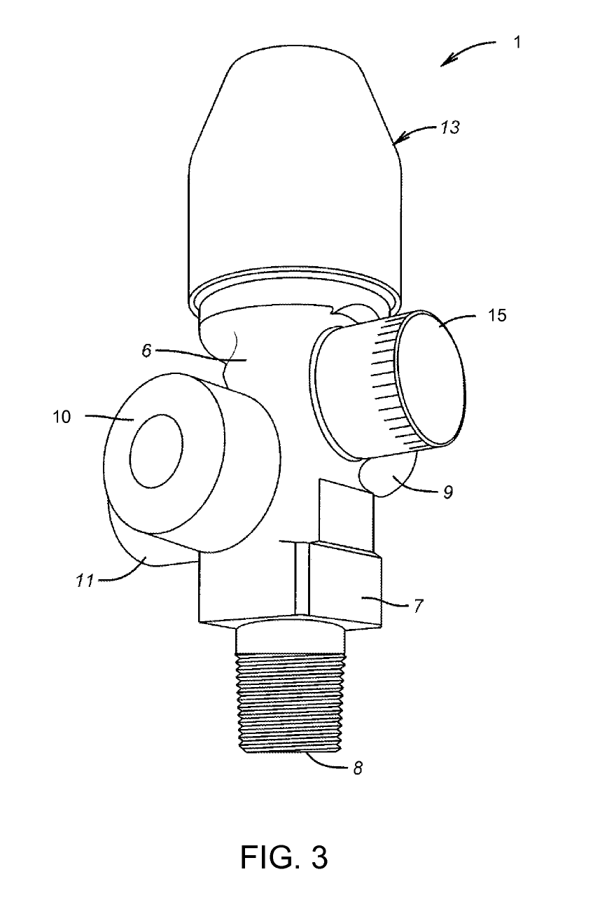

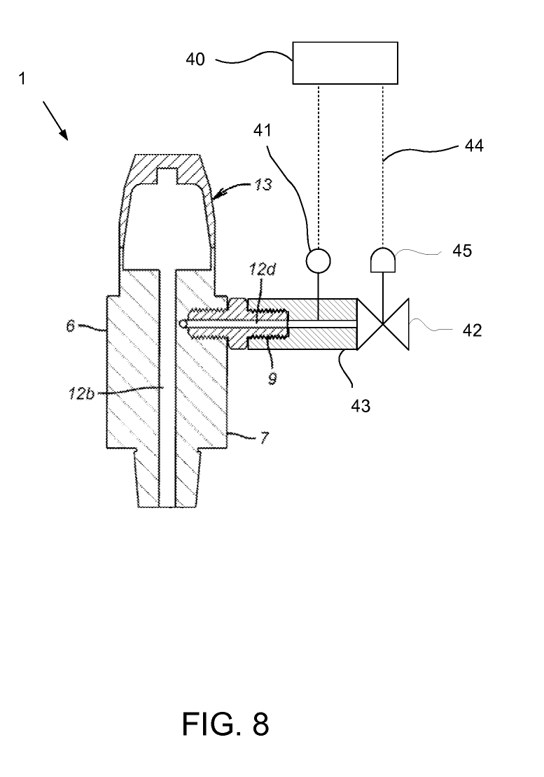

FIG. 3 is a side view of the exterior of the pressure regulator assembly 1. The regulator assembly 1 may further include an isolation valve 15 operable between an open position and a closed position. The isolation valve 15 may be connected to the body 6, such as with one or more fasteners (not shown) or a threaded connection. The isolation valve 15 may provide fluid communication between passage 12c and port 12d (shown in FIG. 4b) in the open position, thereby allowing the discharge of the hazardous fluid from the pressure regulator assembly 1 and to a process line 43 (see FIG. 8) where the hazardous fluid may be directed to one or more downstream systems for use. The isolation valve 15 may have a manual or automatic actuator (not shown). If automatic, the actuator may be electrically, hydraulically, or pneumatically operated.

The pressure regulator assembly 1 may be used to deliver the hazardous fluid at sub-atmospheric or super-atmospheric pressures. For sub-atmospheric applications, the hazardous fluid may be PH₃, BF₃, or AsH₃. For super-atmospheric applications, the hazardous fluid may be GeH₄, H₂Se, COS, TMB (trimethyl boron), GeF₄, AsF₅, SiH₄, NF₃ or PF₃. For sub-atmospheric applications and in the open position, the isolation valve 15 may be further operable to automatically close or remain closed in response to zero and/or positive gage pressure in the process line 43 (see FIG. 8). For super-atmospheric applications, the isolation valve 15 may be further operable to automatically close or remain closed in response to negative gage pressure in the process line 43.

FIG. 4a is a top view of the pressure regulator assembly 1. FIG. 4b is a front cross-section of the pressure regulator assembly 1 taken along cut line 4b-4b of FIG. 4a. FIG. 4c is a side cross-section of the pressure regulator assembly 1 taken along cut line 4c-4c of FIG. 4a. The pressure regulator assembly 1 may have an internal pathway 12. The pathway 12 may include the bore 12b, the ports 12a,d, and the passage 12c. The pathway 12 may extend from the inlet 8 to outlet coupling 9.

During filling of the gas cylinder 2, the fill port 12a may empty directly into the bore 12b. The hazardous fluid may then flow into the chamber 3 of the gas cylinder 2 when the filling valve 11 is open. When dispensing the hazardous fluid from the gas cylinder 2, the hazardous fluid, after entering the bore 12b via the inlet 8 may flow along the internal bore 12b to the pressure regulator 13. As discussed below, pressure of the hazardous fluid may then be reduced by the pressure regulator 13 as the hazardous fluid flows therethrough. The reduced pressure hazardous fluid may then exit the pressure regulator 13 and flow along the internal passage 12c to the isolation valve 15. The isolation valve 15 may be located downstream from the pressure regulator 13 and be in communication with the outlet port 12d. The hazardous fluid may flow through the isolation valve 15. The hazardous fluid may then flow from the isolation valve 15 and through the outlet port 12d to the process line 43 (see FIG. 8).

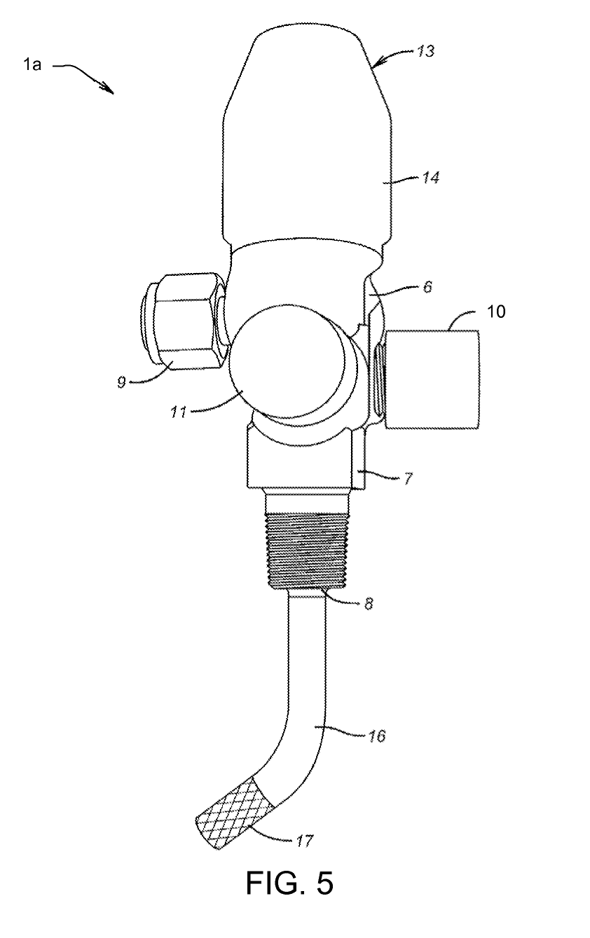

FIG. 5 is a front view of a pressure regulator assembly 1a, according to another embodiment of the present invention. The pressure regulator assembly 1a may further include a vapor inlet dip tube 16. The dip tube 16 may be connected to the body 6, such as by a threaded connection (not shown). The dip tube 16 may have a fritted end 17 to allow passage of gas therethrough and prevent passage of liquid therethrough to prevent liquid spillage should the gas cylinder 2 be knocked over or placed on its side. The fritted end 17 may have a sintered metal or alloy element, such as stainless steel, nickel, or nickel-based alloy. The sintered metal or alloy element may have a pore size equivalent from approximately ten to approximately two hundred microns, such as from ten to fifty microns. The vapor dip tube 16 may extend into the chamber 3 when the base 7 is mounted on the neck 4, thereby providing gas communication between the bore 12b (see FIG. 4C) and the chamber 3.

The dip tube 16 may have a curvature toward the outlet coupling 9. The degree of curvature may range from thirty to sixty degrees as measured from a longitudinal axis of the regulator 1. The dimensions of the dip tube 16 may vary depending upon the size of the gas cylinder 2. For example, for a gas cylinder having a volume of two and a half liters, a length of the dip tube may range from one to five inches with the curved portion accounting for twenty to fifty percent of this length and a diameter of the dip tube may range from one-quarter to three-quarter inch.

Use of the dip tube 16 may be beneficial with cylinders 2 of hazardous materials present in liquefied gas form under pressure. Non-limiting examples of such hazardous materials which are present in liquefied gas form under pressure include PH₃, AsH₃, GeH₄, H₂Se, COS, TMB, GeF₄, and AsF₅. Alternatively, the dip tube may be used with hazardous fluid typically present in only gaseous form.

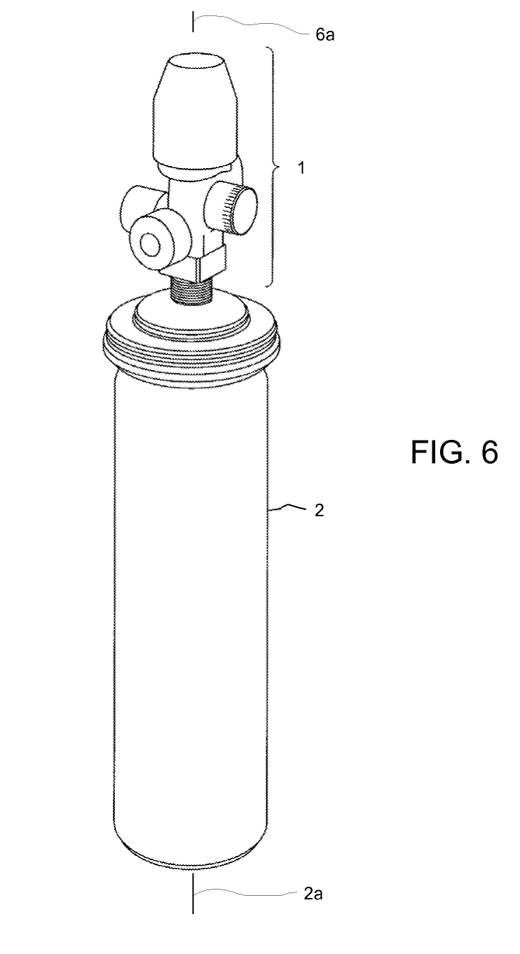

FIG. 6 is a perspective view of the pressure regulator assembly 1 fastened to the gas cylinder 2. When mounted on the gas cylinder 2, a longitudinal axis 6a of the body 6 may be parallel, such as coaxial, with a longitudinal axis 2a of the cylinder.

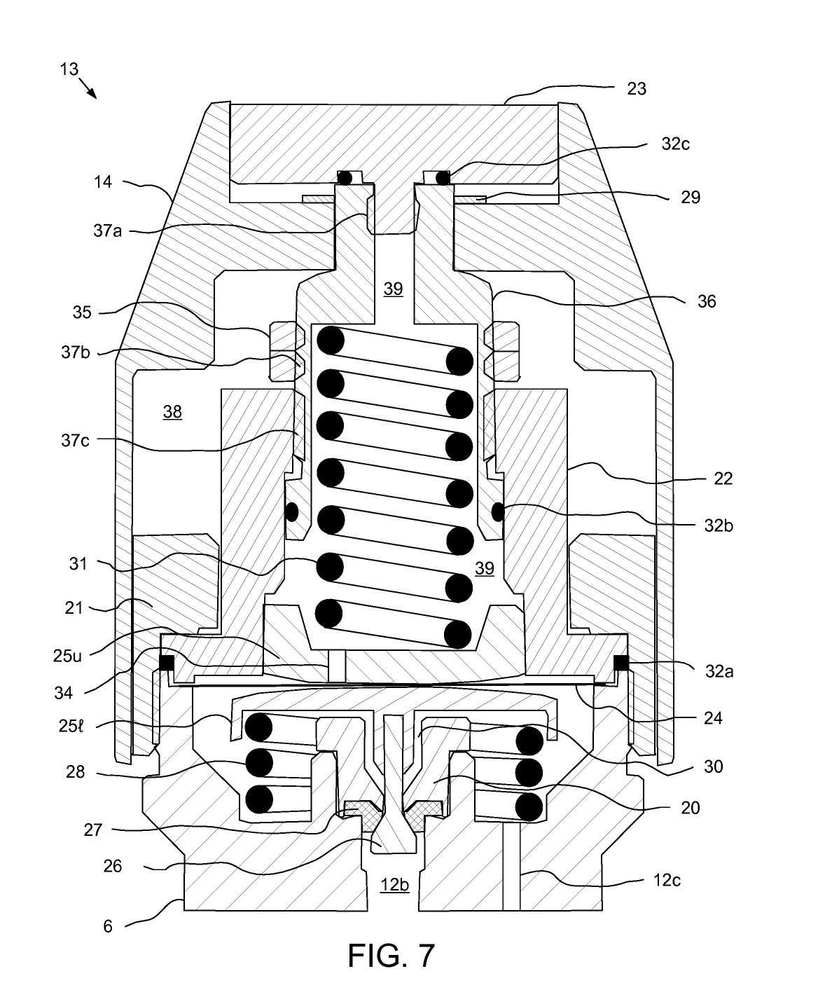

FIG. 7 is a cross-section of one embodiment the pressure regulator 13, which may be part of the pressure regulator assembly 1. The pressure regulator 13 may output the hazardous fluid at a sub-atmospheric pressure or a super-atmospheric pressure depending in part upon the hazardous fluids to be dispensed and the downstream systems to be served. The pressure regulator 13 may include a housing 14 and a gland 22 disposed in a chamber 38 formed by the housing 14. The gland 22 may be connected to the body 6, such as by fastening with nut 21. The housing 14 may be longitudinally connected to an actuator 36, such as by fastening with a snap ring 29. The housing 14 may also be rotationally connected to the actuator 36, such as by splines, press fit, or interference fit (not shown). The actuator 36 may be operably connected to the gland 22, such as by mating threads 37c. A cap 23 may be connected to the actuator 36, such as by a threaded connection 37a, and be received by a recess formed in the housing 14. Each of the housing 14, gland 22, actuator 36, and cap 23 may be made from a metal or alloy, such as stainless steel, brass, aluminum, nickel, or nickel based alloy.

The pressure regulator 13 may further include a diaphragm 24. The diaphragm 24 may be a thin sheet of material. The diaphragm material may be a metal, alloy, or polymer compatible with the hazardous fluid, such as stainless steel or a nickel based alloy. The diaphragm 24 may isolate the housing chamber 38 from the fluid bore 12b and passage 12c. A poppet 26 may be longitudinally movable relative to the body 6. The poppet 26 may have a head sealingly engageable with a seat 27. The seat 27 may be connected to the body 6 by engagement with a shoulder of the body and a shoulder of a fastener, such as seat retainer 20. The seat 27 may be made from a polymer, such as a fluoropolymer. The seat retainer 20 may be connected to the body 6, such as by a threaded connection (not shown). The poppet 26 may also have a stem connected to a lower diaphragm tray 25l, such as by a threaded connection or fastener. A biasing member 28, such as a coil spring, may bias the lower diaphragm tray 25l into engagement with the diaphragm 24. An annular flow passage 30 may be formed between the lower diaphragm tray 25l and the seat retainer 20. The upper diaphragm tray 25u may have a vent 34 formed therethrough for pressure equalization. The diaphragm 24 may be supported by pressing of a periphery thereof between mating shoulders of the gland 22 and the body 6.

An upper diaphragm tray 25u may be disposed in the housing chamber. Rotation of the housing 14 may adjust a preload of a biasing member 31, such as a coil spring. The biasing member 31 may bias the upper diaphragm tray 25u into engagement with the diaphragm 24 and in a longitudinal direction that opposes the bias of the lower diaphragm tray 25l. The upper diaphragm tray 25u may push downward on the poppet 26 (via the diaphragm 24 and the lower diaphragm tray 25l), thereby moving the poppet 26 away from the seat 27 (to an extent which may be limited by a governor 35 discussed below). The lower diaphragm tray 25l may push the poppet 26 upward, thereby moving the poppet 26 toward the seat 27. The hazardous fluid outlet pressure may also push the diaphragm 24 upward and toward the seat 27, thereby adjusting the position of the poppet 26 to maintain the set outlet pressure. Adjustment of the preload of the biasing member 31 via rotation of the housing 14 may adjust the outlet pressure setting of the pressure regulator 13. For sub-atmospheric applications, the outlet pressure may range from approximately fifty to approximately six hundred Torr. Rotation of the housing 14 may cause longitudinal displacement of the actuator 36 due to rotation of the mating threads between the actuator 36 and the gland 22. Longitudinal movement of the actuator 36 toward the lower diaphragm tray 25l may compress the biasing member 31, thereby increasing the set pressure and vice versa.

The hazardous fluid may flow from the bore 12b, through the throat formed between the poppet 26 and the seat 27, through the flow passage 30 and into the passage 12c. The pressure regulator 13 may further include a pressure tap (not shown) in fluid communication with the outlet passage 12c. A pressure gage or sensor (not shown) may be connected to the pressure tap.

To facilitate safe transportation, the pressure regulator 13 may be shifted into a transportation mode. To this end, the housing 14 may be rotated to reduce or remove the preload from the biasing member 31 so that biasing member 28 retains the poppet 26 in the closed position against the seat 27. As a further safeguard, the pressure regulator 13 may include one or more seals, such as gasket 32a and o-rings 32b,c. The seals 32a-c may be made from a polymer, such as an elastomer or a fluoropolymer. The gasket 32a may be disposed between the gland 22 and the body 6, thereby sealing a potential leak path there-between for the hazardous fluid should the diaphragm 24 rupture during transportation and/or service. The o-ring 32b may be disposed between the actuator 36 and the gland 22 and the o-ring 32c may be placed between the cap 23 and the actuator 36 to contain potential leakage through the vent 34 within a chamber 39 formed by the actuator 36 and gland 22.

To facilitate safe operation for sub-atmospheric applications, the pressure regulator 13 may further include a governor, such as a lock-nut (not shown) or two nuts 35 screwed against each other. The nuts 35 may be fastened to the actuator 36, such as by a threaded connection 37b, to limit downward longitudinal displacement of the actuator due to engagement of the nuts with a top of the gland 22. The nuts 35 may engage the gland top before the outlet pressure is increased to greater than or equal to zero gage pressure.

Additionally, the regulator assembly 1 may further include a filter (not shown) located upstream of the pressure regulator 13 to prevent any debris from entering the pressure regulator. The filter may include a sintered metal or alloy element similar to that discussed above for the fritted end 17.

FIG. 8 illustrates the pressure regulator assembly 1 connected to a process line 43, according to another embodiment of the present invention. To facilitate safe operation for sub-atmospheric applications, a pressure sensor 41 may be tapped into the process line 43. The pressure sensor 43 may be in data communication with a programmable logic controller (PLC) 40 via a control line 44. A control valve 42 may be connected to the process line 43. The control valve 42 may include an electric, hydraulic, or pneumatic actuator 45 in communication with the PLC 40 via another control line 44. The PLC 40 may be programmed to monitor the outlet pressure from the regulator 1 and monitor for failure of the regulator assembly 1 as may be indicated by the outlet pressure becoming greater than or equal to zero gauge pressure. In response to failure of the regulator assembly 1, the PLC 40 may close the control valve 42, thereby isolating the positive pressure from sensitive downstream components not capable of handing positive pressure.

Alternatively, the pressure sensor 41 may be connected to the pressure regulator pressure tap (discussed above) and/or the controller 40 may be in communication with the isolation valve 15 (see FIG. 4a or 4b).

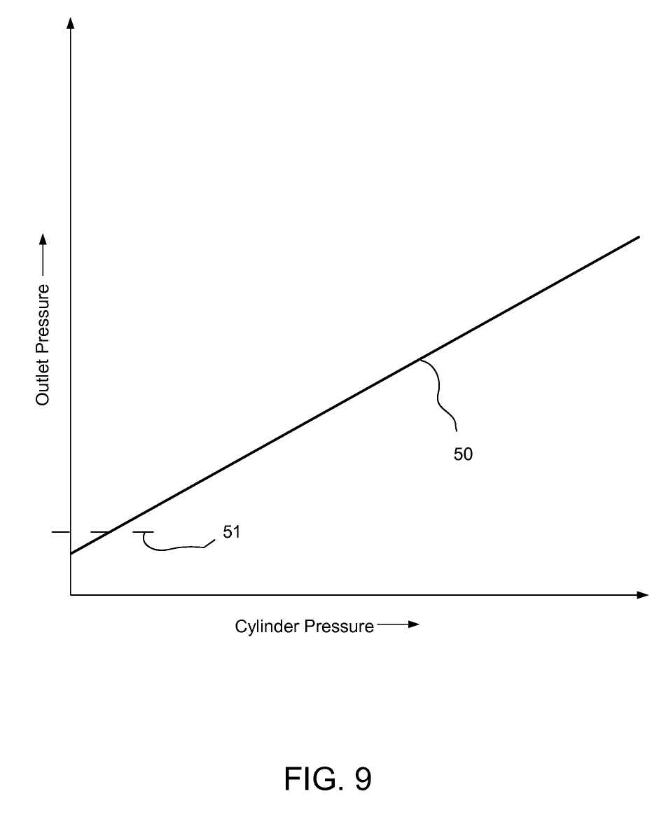

FIG. 9 illustrates further functionality of the PLC 40, according to another embodiment of the present invention. The PLC 40 may further be programmed with performance data 50. For illustrative purpose, the performance data 50 is depicted as a curve, such as a line. However, the PLC 40 may be programmed with the performance data as a formula or table. The performance data 50 may be generated empirically, such as by connecting the regulator assembly 1 to a test cylinder (not shown) containing a minimal amount of nitrogen or helium, such as less than or equal to one bar, so that the regulator will be fully open. The test cylinder may have a pressure sensor. The regulator assembly 1 may then be operated with the test cylinder and both the outlet pressure and the cylinder pressure may be measured during operation.

The PLC 40 may further monitor the outlet pressure and determine the cylinder pressure based on the outlet pressure measurement and the slope of the continued decrease in outlet pressure. Once the cylinder pressure is determined to be nearing empty (as indicated by monitoring the outlet pressure), the PLC 40 may then calculate a remaining pressure in the cylinder 2 using the performance data 50. The PLC 40 may then compare the calculated cylinder pressure to a predetermined pressure 51. Before the PLC 40 detects that the cylinder pressure is less than or equal to the predetermined pressure 51, the PLC 40 may alert an operator. The predetermined pressure 51 may be selected to provide the operator with sufficient notice to take remedial action to prevent unexpected shutdown of the process due to emptying of the cylinder 2. The remedial action may include ordering of another cylinder, switching to a backup cylinder, and/or scheduling a convenient shutdown time to switch cylinders.

Alternatively, instead of calculating the remaining pressure in the gas cylinder 2, the outlet pressure may be directly compared to a predetermined pressure pre-correlated to the predetermined cylinder pressure.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A pressure regulator assembly, comprising:
an integrated body having:
an inlet for connecting to a gas cylinder,
a bore extending from the inlet to a pressure regulator,
a passage extending from the pressure regulator to an outlet, and
a fill port in communication with the bore;
the pressure regulator operable to reduce pressure of a fluid flowing therethrough between the bore and the passage to a sub-atmospheric pressure; and
an isolation valve operable between an open position and a closed position, wherein:
the isolation valve is operable to seal the passage from the outlet in the closed position, and
the isolation valve is operable to provide fluid communication between the outlet and the passage in the open position.

2. The pressure regulator assembly of claim 1, wherein the body is configured such that a longitudinal axis thereof is coaxial with a longitudinal axis of the gas cylinder when the inlet is connected to the gas cylinder.

3. The pressure regulator assembly of claim 1, further comprising a dip tube having a fritted end operable to allow gas flow therethrough and prevent liquid flow therethrough.

4. The pressure regulator assembly of claim 3, wherein the dip tube is curved toward the outlet.

5. The pressure regulator assembly of claim 1, wherein the pressure regulator comprises:
a diaphragm,
a lower diaphragm tray,
a lower spring biasing the lower tray into engagement with the diaphragm,
a poppet connected to the lower diaphragm tray and having a head operable to engage a seat of the body,
an upper diaphragm tray,
an upper spring biasing the upper tray into engagement with the diaphragm, and
a gland connected to the body.

6. The pressure regulator assembly of claim 5, further comprising a seal disposed between the gland and the body.

7. The pressure regulator assembly of claim 5, wherein the pressure regulator further comprises an actuator operable to adjust a preload of the upper spring.

8. The pressure regulator assembly of claim 7, further comprising a seal disposed between the actuator and the gland.

9. The pressure regulator assembly of claim 7, further comprising:
a cap connected to the actuator, and
a seal disposed between the actuator and the cap.

10. The pressure regulator assembly of claim 7, further comprising a governor operable to limit operation of the actuator.

11. The pressure regulator assembly of claim 6, wherein:
the pressure regulator further comprises a cap connected to the housing, and
the housing is disposed in the chamber.

12. A fluid delivery system, comprising:
a gas cylinder; and
a pressure regulator assembly, comprising:
an integrated body having:
an inlet connected to the gas cylinder,
a bore extending from the inlet to a pressure regulator,
a passage extending from the pressure regulator to an outlet,
a fill port in communication with the bore, and
a longitudinal axis coaxial with a longitudinal axis of the gas cylinder;
the pressure regulator operable to reduce pressure of a fluid flowing therethrough between the bore and the passage; and
an isolation valve operable between an open position and a closed position, wherein:
the isolation valve is operable to seal the passage from the outlet in the closed position, and
the isolation valve is operable to provide fluid communication between the outlet and the passage in the open position.

13. The fluid delivery system of claim 12, further comprising a pressure sensor in communication with the outlet.

14. The fluid delivery system of claim 13,
further comprising a programmable logic controller (PLC) in communication with the pressure sensor, wherein:
the PLC comprises performance data of the pressure regulator assembly, and
the PLC is operable to calculate pressure in the gas cylinder using the performance data and the pressure sensor.

15. The fluid delivery system of claim 13,
further comprising a programmable logic controller (PLC) in communication with the pressure sensor, wherein:
the PLC is also in communication with the isolation valve or a downstream control valve, and
the PLC is further operable to close the isolation valve or downstream control valve in response to detection of failure of the pressure regulator using the pressure sensor.

16. The fluid delivery system of claim 12, wherein:
the regulator is operable to reduce the pressure to a sub-atmospheric pressure, and
the isolation valve is further operable to close in response to positive gauge pressure in the outlet.

17. A failsafe pressure regulator assembly, comprising:
an integrated body having:
an inlet for connecting to a gas cylinder,
a bore extending from the inlet to a pressure regulator,
a passage extending from the pressure regulator to an outlet, and
a fill port in communication with the bore;
the pressure regulator operable to reduce pressure of a fluid flowing therethrough between the bore and the passage to a sub-atmospheric pressure and comprising:
a gland connected to the body,
a diaphragm,
an actuator operable to adjust the sub-atmospheric pressure,
a governor operable to limit the adjustability to a sub-atmospheric pressure, and
one or more seals operable to contain the fluid in the gland and the actuator in response to failure of the diaphragm; and
an isolation valve operable between an open position and a closed position, wherein:
the isolation valve is operable to seal the passage from the outlet in the closed position, and
the isolation valve is operable to provide fluid communication between the outlet and the passage in the open position.

18. A method of dispensing hazardous fluid from a gas cylinder, comprising:
connecting a system to a process line, wherein the system comprises a pressure regulator assembly and the gas cylinder;
setting the pressure regulator assembly to feed the hazardous fluid to a process via the process line;
dispensing the hazardous fluid from the cylinder to the process line using the pressure regulator assembly; and
monitoring operation of the regulator using a pressure sensor in communication with an outlet of the pressure regulator assembly.

19. The method of claim 18, wherein the operation is monitored by a programmable logic controller (PLC) in communication with the pressure sensor.

20. The method of claim 19, wherein:
the PLC includes a storage medium having predetermined performance data of the pressure regulator assembly, and
the method further comprises calculating pressure in the gas cylinder using the performance data and the pressure sensor.

21. The method of claim 19, further wherein:
the PLC monitors for failure of the pressure regulator assembly, and
the PLC is operable to close a valve in response to failure of the regulator, thereby isolating components downstream of the valve from the regulator.

22. The method of claim 18, further comprising comparing the measured pressure to a predetermined pressure to provide warning of emptying of the gas cylinder.
